(19) United States
(12) Patent Application Publication
(10) Pub. No.: US 2007/0082836 A1
(43) Pub. Date: Apr. 12, 2007

(54) MIXTURE OF SURFACE-ACTIVE COMPOUNDS FOR USE IN CLEANING PREPARATIONS

(76) Inventors: Sabine Both, Neuss (DE); Corinna Boehme, Dormagen (DE); Rainer Eskuchen, Langenfeld (DE); Melanie Maik, Duesseldorf (DE); Hans-Christian Raths, Monheim (DE)

Correspondence Address: COGNIS CORPORATION;PATENT DEPARTMENT, 300 BROOKSIDE AVENUE, AMBLER, PA, 19002, US

(21) Appl. No.: 11/531,320

(22) Filed: Sep. 13, 2006

(30) Foreign Application Priority Data
Sep. 14, 2005 (DE) 10 2005 044 028.2

(51) Int. Cl. C11D 1/72

(52) U.S. Cl. 510/506

(57) ABSTRACT

The disclosed invention relates to mixtures of at least two structurally different surface-active compounds, one surface-active compound a) being selected from an hydroxyl mixed ether compound of formula (I):
R¹O[CH₂CH₂O]ₓCH₂CH(OM)R² (I)
in which R¹ is a linear or branched alkyl and/or alkenyl group containing 4 to 22 carbon atoms or an R²—CH(OH)CH₂ group, where R² is a linear or branched alkyl and/or alkenyl group containing 8 to 16 carbon atoms, x is a number from 40 to 80 and M is a hydrogen atom or a saturated alkyl group containing 1 to 18 carbon atoms. The second surface-active compound b) is preferably selected from a structurally different hydroxy mixed ether compound of formula (II):
R³O[CH₂CH₂O]_{y}[CH₂CHCH₃O]_{z}CH₂CH(OH)R⁴ (II) These mixtures are capable of improving the drying of hard surfaces after washing and, at the same time, also positively influence clear-rinse performance.

### CROSS-REFERENCE TO RELATED APPLICATIONS

This application claims priority under 35 U.S.C. § 119 from German patent application no. 10 2005 044 028.2, filed Sep. 14, 2005.

### BACKGROUND OF THE INVENTION

1. Technical Field

This invention relates to mixtures of surface-active compounds for use in cleaning preparations, more particularly in automatic dish detergents.

The cleaning of hard surfaces and particularly the washing of dishes impose particular demands on the preparations used. This applies in particular to automatic dishwashing. The three components of the automatic system are detergent, rinse agent and regenerating salt. The key functions of the principal constituent, the detergent, are soil separation, soil dispersion, the binding of residual water hardness and corrosion inhibition.

2. Background Art

Compared with the standard “clear rinse” system (detergent, salt and rinse agent as separate products), conventional multifunctional automatic dish detergents (ADDs) show much poorer drying behavior. By drying behavior is meant the extent to which tableware cleaned with a dish detergent still has water, preferably in the form of drops, on its surface after undergoing the dishwashing process. The water remaining on the surface then either has to be mechanically removed (for example by wiping) or the tableware has to be air-dried, i.e. the user has to wait for the water to evaporate. However, this leaves the surface with residues (for example lime and/or surfactant residues or other residues which were dissolved or dispersed in the water) which lead to unsightly stains or streaks. This applies especially to bright or transparent surfaces, such as glass or metal for example. Accordingly, modern dish detergents contain rinse agents to improve the drainage of water from the surfaces of the tableware. There are rinse agents which do not dry equally well on all substrates, such as plastic for example. In order to eliminate this problem, elaborate rinse agents containing silicone compounds or fluorinated compounds, for example, have been formulated, as described in U.S. Pat. No. 5,880,089 and in US 2005/0143280 A1. Unfortunately, these compounds do not biodegrade readily, if at all, and in some cases actually pose a threat to the environment.

The increased use of multifunctional compositions (i.e. the combination of, for example, detergents, rinse agents and optionally water softeners in a supply form) has resulted in a deterioration in drying behavior by comparison with the traditional rinse agent. Accordingly, a search has been conducted to find ways of improving the drying performance of hard surface cleaners and particularly dish detergents. EP 1 306 423 A2 discloses water-based detergents containing alkyl ether sulfates and amphoteric glycine compounds which are capable of improving the drying behavior of dish detergents. DE 100 45 289 A1 describes manual dish detergents which contain certain quaternary ammonium compounds and alkyl ether sulfates alongside one another and which show particularly good drying behavior.

In addition, the cleaning performance and particularly the clear-rinse performance of the detergents should not be adversely affected by additives. Ideally, an additive should actually improve the overall performance of the detergent.

A key parameter in dishwashing is clear-rinse performance. This determines the extent of deposits on the items of tableware after washing. The deposits are essentially mineral compounds, more particularly Ca and/or Mg salts, but also surfactant residues. However, it is principally lime which leads to the deposits so disliked by the consumer. In order to reduce the extent of these deposits, conventional dish detergents, particularly automatic dish detergents, generally contain so-called rinse agents. Rinse agents are usually mixtures of low-foaming nonionic surfactants, typically fatty alcohol polyethylene/polypropylene glycidyl ethers, solubilizers (for example cumemesulfonate), organic acids (for example citric acid) and solvents (for example ethanol). The function of the rinse agents is to influence the interfacial tension of the water in such a way that it is able to drain from the tableware in the form of a very thin, coherent film, so that no drops of water, streaks or films are left behind after the subsequent drying phase. There are two kinds of deposits, namely: spotting, which is caused by drying water droplets, and filming, i.e. layers formed by the drying of thin films of water. At present, volunteers are used for visually evaluating the parameters of spotting and filming on cleaned items of tableware, for example plates, glasses, knives, etc.

### BRIEF SUMMARY OF THE INVENTION

The present inventors have now found that the combination of certain surface-active compounds is capable of improving the drying behavior and clear-rinse performance of hard surface cleaners, particularly dish detergents, and at the same time is ecologically safe.

Accordingly, in a first embodiment, the present invention relates to mixtures containing at least two structurally different surface-active compounds, one or more from the compounds a) and one or more structurally different compounds from groups b1)-b8), the surface-active compound a) being selected from one or more hydroxy mixed ether compounds corresponding to general formula (I):
R¹O[CH₂CH₂O]ₓCH₂CH(OM)R² (I)
in which R¹ is a linear or branched alkyl and/or alkenyl group containing 4 to 22 carbon atoms or an R²—CH(OH)CH₂ group, where R² is a linear or branched alkyl and/or alkenyl group containing 8 to 16 carbon atoms, x is a number from 40 to 80 and M is a hydrogen atom or a saturated alkyl group containing 1 to 18 carbon atoms,
and the one or more structurally different surface-active compounds b) being selected from the groups b1) to b8):
b1) hydroxy mixed ether compounds corresponding to formula (II):
R³O[CH₂CH₂O]_{y}[CH₂CHCH₃O]_{z}CH₂CH(OH)R⁴ (II)
in which R³ is a linear or branched alkyl and/or alkenyl group containing 8 to 22 carbon atoms, R⁴ is a linear or branched alkyl and/or alkenyl group containing 8 to 16 carbon atoms, y is a number from 10 to 35, z is 0 or a number from 1 to 5, with the proviso that, where R³=R¹ and at the same time R⁴=R², z must be at least 1,
   b2) ethoxylated fatty alcohols corresponding to general formula (III):
   R⁵—(OC₂H₄)_{z}—OH (III)
in which R⁵ represents linear or branched alkyl and/or alkenyl groups containing 8 to 22 carbon atoms and n is a number from 1 to 20,
   b3) esters of (poly)glycols corresponding to general formula (IV)
   R⁶CO—(OC₂H₄)ₘ—OR⁷ (IV)
in which R⁶ represents alkyl and/or alkenyl groups containing 7 to 21 carbon atoms and m is a number from 11 to 100 and R⁷ is a hydrogen atom or a CO—R⁶ group, and/or
   b4) alkyl (oligo)glycosides corresponding to the general formula (V)
   R⁸O—[G]ₚ (V)
where R⁸ is an alkyl and/or alkenyl group containing 4 to 22 carbon atoms, G is a sugar unit containing 5 or 6 carbon atoms and p is a number from 1 to 10,
   b5) betaines,
   b6) compounds corresponding to general formula (VI): 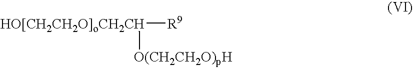
in which R⁹ is a linear or branched alkyl and/or alkenyl group containing 4 to 22 carbon atoms, o is a number from 1 to 20 and the index p is 0 or a number from 1 to 20,
   b7) compounds corresponding to general formula (VII):
   R¹⁰CH(OR¹¹)CH₂—OR¹¹ (VII)
in which R¹⁰ is a saturated or unsaturated, branched or unbranched alkyl or alkenyl group containing 8 to 16 carbon atoms and the substituents R¹¹ independently of one another symbolize a group (CH₂CH₂O)ᵣCH₂CH(OH)R¹², r in each substituent R¹¹ independently standing for 0 or a number from 1 to 50 and R¹² being a saturated or unsaturated, branched or unbranched alkyl or alkenyl group containing 8 to 16 carbon atoms, and
   b8) compounds corresponding to general formula (VIII):
   NR¹³₃ (VIII)
in which the substituents R¹³ independently of one another represent a (CH₂CH₂O)ₛCH₂CH(OH)R¹⁴ group or an alkyl group containing 8 to 16 carbon atoms and s for each substituent R¹³ independently stands for 0 or a number from 1 to 50,
   with the proviso that the ratio by weight between the surface-active compounds a) and b) is in the range from 10:1 to 1:10.

As noted above, a feature of the mixtures of the invention is that the one or more compounds from group a) and the compounds from one or more of groups b1) to b8) are structurally different. In particular, when a b1) hydroxy mixed ether compound of formula (II) is present, it is structurally different from the a) hydroxy mixed ether compounds of formula (I).

### DETAILED DESCRIPTION OF THE INVENTION

The mixtures according to the invention contain compounds of type a) as a compulsory constituent. These compounds of so-called hydroxy mixed ethers or derivatives thereof. Hydroxy mixed ethers (HMEs) correspond to the broad general formula R′O[AO]ₓCH₂CH(OM)R″, in which R′ is a linear or branched alkyl and/or alkenyl group containing 4 to 22 carbon atoms, R″ is a linear or branched alkyl and/or alkenyl group containing 2 to 22 carbon atoms, x has a value of 10 to 80, AO is an ethylene oxide, propylene oxide or butylene oxide group and M is a hydrogen atom or an alkyl or alkenyl group.

Hydroxy mixed ethers of the type in question are known from the literature and are described, for example, in German patent application DE 19738866. They are prepared, for example, by reaction of 1,2-epoxyalkanes (R²CHOCH₂), where R″ is an alkyl and/or alkenyl group containing 2 to 22 and more particularly 6 to 16 carbon atoms, with alkoxylated alcohols. Hydroxy mixed ethers preferred for the purposes of the invention are those derived from alkoxylates of monohydric C₄₋₁₈ alcohols with the formula R′—OH, R′ being an aliphatic, saturated, linear or branched alkyl group, more particularly containing 6 to 16 carbon atoms. Examples of suitable straight-chain alcohols are butan-1-ol, caproic alcohol, oenanthic alcohol, caprylic alcohol, pelargonic alcohol, capric alcohol, undecan-1-ol, lauryl alcohol, tridecan-1-ol, myristyl alcohol, pentadecan-1-ol, palmityl alcohol, heptadecan-1-ol, stearyl alcohol, nonadecan-1-ol, arachidyl alcohol, heneicosan-1-ol, behenyl alcohol and the technical mixtures thereof obtained in the high-pressure hydrogenation of technical methyl esters based on fats and oils. Examples of branched alcohols are so-called oxo alcohols which generally contain 2 to 4 methyl groups as branches and are produced by the oxo process and so-called Guerbet alcohols which are branched in the 2-position by an alkyl group. Suitable Guerbet alcohols are 2-ethyl hexanol, 2-butyl octanol, 2-hexyl decanol and/or 2-octyl dodecanol. The alcohols are used in the form of their alkoxylates which are prepared in known manner by reaction of the alcohols with ethylene oxide.

There are also other known hydroxy mixed ethers, namely those which contain more than one free hydroxyl group in the molecule. Such compounds can be prepared, for example, by reacting diols, preferably alkylene glycols and derivatives thereof, preferably polyethylene glycols, with two mols of an alkyl epoxide (R—CHOCH₂) per mol of the diol.

The present invention arises out of the discovery that the presence of selected HMEs or derivatives therefore, namely compounds corresponding to general formula (I), in combination with one or more of structurally different surface-active compounds of type b) can have advantageous properties in regard to the drying and/or clear-rinse behavior of cleaning formulations for hard surfaces, more especially dish detergents.

Surface-Active Compounds of Type a)

The compounds are commercially available hydroxy mixed ethers surfactants corresponding to general formula (I):
R¹O[CH₂CH₂O]ₓCH₂CH(OM)R² (I)
in which R¹ is a linear or branched alkyl and/or alkenyl group containing 4 to 22 carbon atoms or an R²—CH(OH)CH₂ group, where R² is a linear or branched alkyl and/or alkenyl group containing 8 to 16 carbon atoms, x is a number from 40 to 80 and M is a hydrogen atom or a saturated alkyl group containing 1 to 18 carbon atoms. Compounds of type a) corresponding to general formula (I) which contain at least one free hydroxyl group (═—OH) are advantageously used.

Hydroxy mixed ethers derived from ethoxylates of monohydric alcohols with the formula R¹—OH(R¹=a linear alkyl group, x=40 to 60) containing 6 to 18 carbon atoms, preferably 6 to 16 and more particularly 8 to 10 carbon atoms are preferred for the purposes of the invention. Other compounds of general formula (I) preferably present in the mixtures according to the invention are those in which the index x is a number from 40 to 70, preferably 40 to 60 and more particularly 40 to 50 and M is a hydrogen atom. Hydroxy mixed ethers of formula (I), in which R¹ is an alkyl group containing 8 to 10 carbon atoms, more particularly based on a native fatty alcohol, R² is an alkyl group containing 10 carbon atoms, more particularly a linear alkyl group, and is has a value of 40 to 60, are most particularly preferred. Other preferred mixtures are those which contain a compound of general formula (I), in which R¹ is an alkyl and/or alkenyl group containing 8 to 10 carbon atoms and R² is an alkyl or alkenyl group containing 8 to 10 carbon atoms and x has a value of 40 to 50, M again being a hydrogen atom, as the surface active compound of type a). However, compounds of general formula (I), in which R¹ is an alkyl or alkenyl group containing 8 to 10 carbon atoms, R² is an alkyl group containing 8 to 12 carbon atoms and M is a saturated alkyl group containing 1 to 6 and preferably 1 to 4 carbon atoms, are also suitable as the compounds of type a). Compounds of the latter type do not contain any free hydroxyl groups, the hydroxyl functions having been alkylated with suitable reagents, for example alkyl halides.

Surface-Active Compounds of Type b)

The present invention presupposes that at least one compound of type a) is used in combination with one of the compounds of type b) described in the following.

Surface-Active Compounds of Type b1)

These compounds are also HMEs, but with a structure different from that of the HMEs of general formula (I). The compounds of type b1) correspond to formula (II):
R³O[CH₂CHCH₃O]_{z}[CH₂CH₂O]_{y}CH₂CH(OH)R⁴ (II)
in which R³ is a linear or branched alkyl and/or alkenyl group containing 8 to 22 carbon atoms, R⁴ is a linear or branched alkyl and/or alkenyl group containing 8 to 16 carbon atoms, y is a number from 10 to 35, z is 0 or must have a value of 1 to 5. It can be of advantage if, where R³=R¹ and at the same time R⁴=R², the compounds of formula b1) selected are those in which the index x is at least 1. If mixtures of the surface-active compounds of type a) with those of type b1) are used, only those mixtures in which the molecules are structurally different from one another correspond to the technical teaching of the present invention. In other words, structurally different compounds must always be present alongside one another. Particularly preferred compounds of type b1) are, for example, those in which, in formula (II), the index y is a number from 20 to 30 and preferably 20 to 25. Other preferred compounds of type b1) are those in which, in formula (II), R³ is an alkyl group containing 8 to 12 and preferably 8 to 10 carbon atoms, R⁴ is an alkyl group containing 10 to 12 and preferably 10 carbon atoms, y is a number from 15 to 35, preferably 20 to 30, and z is a number from 1 to 3, preferably the number 1.

Other preferred mixtures are those which contain a compound of general formula (II), in which R³ is an alkyl and/or alkenyl group containing 11 to 18 carbon atoms and R⁴ is an alkyl or alkenyl group containing 8 to 10 carbon atoms and y is a number from 20 to 35, as the surface-active compound of type b1).

Mixtures containing a compound of general formula (II), in which R³ is an alkyl and/or alkenyl group containing 8 to 12 carbon atoms and R⁴ is an alkyl or alkenyl group containing 8 to 10 carbon atoms and y is a number from 20 to 35 and z is a number from 1 to 3, as the surface-active compound of type b1) also represent preferred mixtures.

The compounds of type b1) are also hydroxy mixed ether derivatives which can be prepared by ring-opening reaction of propoxylated and/or ethoxylated fatty alcohols with alkyl epoxides in alkaline medium. With derivatives of type b1) and with all other mixed alkoxylates mentioned herein, i.e. alkoxylates which contain both a propylene oxide unit CH₂CHCH₃O(PO) and an ethylene oxide unit CH₂CH₂O(EO), it is possible that, in the direction of the C atom with the free hydroxyl group, first the EO groups and then the PO groups are arranged blockwise, the opposite sequence (first PO, then EO) also being possible. In addition, the alkoxide groups may also be present in statistical distribution (randomized) in the molecule. Both block alkoxylates and random alkoxylates may also be used alongside one another.

Surface-Active Compounds of Type b2)

These compounds are fatty alcohol ethoxylates known per se corresponding to general formula (III) R⁵—(OC₂H₄)_{z}—OH, in which R⁵ represents linear or branched alkyl and/or alkenyl groups containing 8 to 22 carbon atoms and z is a number from 1 to 20, preferably 1 to 15 and more particularly 1 to 10. Typical examples are the adducts of on average 1 to 20 mol caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol and the technical mixtures thereof obtained, for example, in the high-pressure hydrogenation of technical methyl esters based on fats and oils or aldehydes from Roelen's oxo synthesis and as monomer fraction in the dimerization of unsaturated fatty alcohols. Adducts of 10 to 40 mol ethylene oxide with technical C₁₂₋₁₈ fatty alcohols, such as for example coconut oil, palm oil, palm kernel oil or preferably tallow fatty alcohol, are preferred. Particularly preferred fatty alcohol ethoxylates are based on tallow fatty alcohols ethoxylated with 2 to 10 and preferably 2 to 5 mol ethylene oxide per mol alcohol.

Surface-Active Compounds of Type b3)

These compounds are mono- and/or preferably diesters of glycol and especially polyglycols and are also known and commercially available. They correspond to the formula (IV) R⁶CO—(OC₂H₄)ₘ—OR⁷, in which R⁶ is an alkyl and/or alkenyl group containing 7 to 21 carbon atoms, m is a number from 11 to 100 and R⁷ is a hydrogen atom or a CO—R⁶ group. The formula encompasses symmetrical (R⁶=R⁷) and asymmetrical compounds (R⁶ ≠R⁷). Compounds of type b3) based on polyethylene glycols with molecular weights of 1,000 to 10,000, preferably 1,500 to 6,000 and more particularly 1500 to 3,000 are preferably used in the preparations according to the invention. Diester compounds of type b3) are particularly preferred. Besides compounds of type b3), polyglycols may also be present as secondary products from the production process.

Surface-Active Compounds of Type b4)

These compounds are also known as alkyl (oligo)glycosides. Alkyl and alkenyl oligoglycosides are known nonionic surfactants which correspond to the formula (V) R⁸O—[G]ₚ, in which R⁸ is an alkyl and/or alkenyl group containing 4 to 22 carbon atoms, G is a sugar unit containing 5 or 6 carbon atoms and p is a number from 1 to 10. They may be obtained by the relevant methods of preparative organic chemistry. The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides. The index p in the general formula indicates the degree of oligomerization (DP), i.e. the distribution of mono- and oligoglycosides, and is a number from 1 to 10. Whereas p in a given compound must always be an integer and, above all, may assume a value of 1 to 6, the value p for a certain alkyl oligoglycoside is an analytically determined calculated quantity which is generally a broken number. Alkyl and/or alkenyl oligoglycosides having an average degree of oligomerization p of 1.1 to 3.0 are preferably used. Alkyl and/or alkenyl oligoglycosides having a degree of oligomerization of less than 1.7 and, more particularly, between 1.2 and 1.4 are preferred from the applicational point of view. The alkyl or alkenyl radical R⁸ may be derived from primary alcohols containing 4 to 11 and preferably 8 to 10 carbon atoms. Typical examples are butanol, caproic alcohol, caprylic alcohol, capric alcohol and undecyl alcohol and the technical mixtures thereof obtained, for example, in the hydrogenation of technical fatty acid methyl esters or in the hydrogenation of aldehydes from Roelen's oxosynthesis. Alkyl oligoglucosides having a chain length of C₈ to C₁₀ (DP=1 to 3), which are obtained as first runnings in the separation of technical C₈₋₁₈ coconut oil fatty alcohol by distillation and which may contain less than 6% by weight of C₁₂ alcohol as an impurity, and also alkyl oligoglucosides based on technical C_{9/11} oxoalcohols (DP=1 to 3) are preferred. In addition, the alkyl or alkenyl radical R⁸ may also be derived from primary alcohols containing 12 to 22 and preferably 12 to 14 carbon atoms. Typical examples are lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and technical mixtures thereof which may be obtained as described above. Alkyl oligoglucosides based on hydrogenated C_{12/14} cocoalcohol with a DP of 1 to 3 are preferred.

Surface-Active Compounds of Type b5)

Betaines are known surfactants which are mainly produced by carboxyalkylation, preferably carboxymethylation, of aminic compounds. The starting materials are preferably condensed with halocarboxylic acids or salts thereof, more particularly with sodium chloroacetate, one mol salt being formed per mol betaine. The addition of unsaturated carboxylic acids, such as acrylic acid for example, is also possible. Examples of suitable betaines are the carboxyalkylation products of secondary and, in particular, tertiary amines corresponding to formula (1): 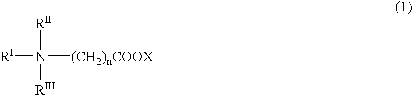
in which R^{I} stands for alkyl and/or alkenyl groups containing 6 to 22 carbon atoms, R^{II} stands for hydrogen or alkyl groups containing 1 to 4 carbon atoms, R^{III} stands for alkyl groups containing 1 to 4 carbon atoms, n is a number from 1 to 6 and X is an alkali metal and/or alkaline earth metal or ammonium. Typical examples are the carboxymethylation products of hexyl methyl amine, hexyl dimethyl amine, octyl dimethyl amine, decyl dimethyl amine, dodecyl methyl amine, dodecyl dimethyl amine, dodecyl ethyl methyl amine, C_{12/14} cocoalkyl dimethyl amine, myristyl dimethyl amine, cetyl dimethyl amine, stearyl dimethyl amine, stearyl ethyl methyl amine, oleyl dimethyl amine, C_{16/18} tallow alkyl dimethyl amine and technical mixtures thereof.

Other suitable betaines are carboxyalkylation products of amidoamines corresponding to formula (2): 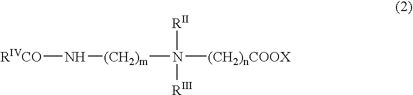
in which R^{IV}CO is an aliphatic acyl group containing 6 to 22 carbon atoms and 0 or 1 to 3 double bonds, m is a number from 1 to 3 and R^{II}, R^{III}, n and X are as defined above. Typical examples are reaction products of fatty acids containing 6 to 22 carbon atoms, namely caproic acid, caprylic acid, capric acid, lauric acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof, with N,N-dimethyl aminoethyl amine, N,N-dimethyl aminopropyl amine, N,N-diethyl aminoethyl amine and N,N-diethyl aminopropyl amine which are condensed with sodium chloroacetate. It is preferred to use a condensation product of C_{8/18} cocofatty acid-N,N-dimethyl aminopropyl amide with sodium chloroacetate.

Other suitable starting materials for the betaines to be used in accordance with the invention are imidazolines corresponding to formula (3): 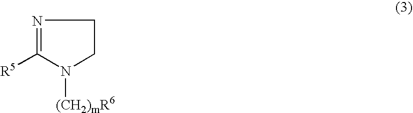
in which R^{V} is an alkyl group containing 5 to 21 carbon atoms, R⁶ is a hydroxyl group, an OCOR^{V} or NHCOR^{V} group and m=2 or 3. Imidazolines are also known compounds which may be obtained, for example, by cyclizing condensation of 1 or 2 mol of fatty acid with polyfunctional amines, for example aminoethyl ethanolamine (AEEA) or diethylene triamine. The corresponding carboxyalkylation products are mixtures of different open-chain betaines. Typical examples are condensation products of the above-mentioned fatty acids with AEEA, preferably imidazolines based on lauric acid or—again —C_{12/14} cocofatty acid which are subsequently betainized with sodium chloroacetate.
Surface-Active Compounds of Type b6)

These also known nonionic compounds are prepared, for example, by reacting alkyl epoxides with ethylene glycol and then with more ethylene oxide. They are also commercially available and correspond to general formula (VI): 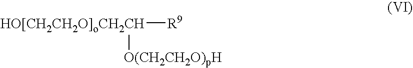
in which R⁹ is a linear or branched alkyl and/or alkenyl group containing 4 to 22 carbon atoms, o is a number from 1 to 20 and the index p is 0 or a number from 1 to 20.
Surface-Active Compounds of Type b7)

The compounds, which may also be termed hydroxy mixed ethers, correspond to general formula (VII):
R¹⁰CH(OR¹¹)CH₂—OR¹¹ (VII)
in which R¹⁰ is a saturated or unsaturated, branched or unbranched alkyl or alkenyl group containing 8 to 16 carbon atoms and the substituents R¹¹ independently of one another symbolize a group (CH₂CH₂O)ᵣCH₂CH(OH)R¹², in which r in each of the R¹¹ substituents independently stands for 0 or a number from 1 to 50 and R¹² is a saturated or unsaturated, branched or unbranched alkyl or alkenyl group containing 8 to 16 carbon atoms. These compounds are prepared, for example, by reacting compounds of formula (III) with more alkylene oxide having C chains of 8 to 18 carbon atoms under the conditions of an alkaline catalysis. Surface-Active Compounds of Type b8)

These are nitrogen-containing compounds corresponding to general formula (VIII):
NR¹³₃ (VIII)
in which the substituents R¹³ independently of one another represent a group (CH₂CH₂O)ₛ—CH₂CH(OH)R¹⁴ or an alkyl group containing 8 to 16 carbon atoms and s in each substituent R¹³ independently represents 0 or a number from 1 to 50. Compounds of type b8) are obtainable, for example, by ethoxylation of alkylamines or triethanolamine and subsequent reaction with C₈₋₁₈ alkylene oxides under the conditions of alkaline catalysis.

Compounds b1) to b8) may be individually combined with at least one compound of type a). Binary mixtures of a) and a compound of type b), more particularly a compound of type b1), are particularly preferred. Mixture of various compounds of type b) may also be combined with HMEs of type a). In the case of mixtures containing several different compounds of type b), it can be of advantage to use these compounds in a ratio by weight of a):b1)-b8) of 1:1.

Besides the surface-active compounds described above, it can be of advantage to use other surface-active compounds (i.e. surfactants). Suitable other surface-active compounds are, in particular, pure fatty alcohols. Fatty alcohols are understood to be primary aliphatic alcohols corresponding to the formula ROH, where R is an aliphatic, linear or branched hydrocarbon radical containing 6 to 22 carbon atoms and 0 and/or 1, 2 or 3 double bonds. Typical examples are caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, octyl dodecanol, erucyl alcohol and brassidyl alcohol and the technical mixtures thereof obtained, for example, in the high-pressure hydrogenation of technical methyl esters based on fats and oils or aldehydes from Roelen's oxo synthesis and as monomer fraction in the dimerization of unsaturated fatty alcohols. Preferred fatty alcohols are technical C₁₂₋₁₈ fatty alcohols such as, for example, coconut oil, palm oil, palm kernel oil or tallow fatty alcohol.

The compounds of type a) and b) are present alongside one another in a ratio by weight of 10:1 to 1:10 in the mixtures according to the invention. However, preferred mixtures can be those where the surface-active compounds of type a) and b) are present alongside one another in a ratio by weight of 5:1 to 1:5, preferably 3:1 to 1:3, more preferably 2:1 to 1:2 and most preferably 1:1. As already mentioned, the compounds of type b1) to b8) may also be present alongside one another in any mixtures. However, the mixtures preferably consist of only one compound of type a) and one compound of type b).

The above-described mixtures are preferably suitable for use in cleaning preparations, more particularly in dish detergents and above all in automatic dish detergents. The mixtures may be used to improve the drying behavior and/or clear-rinse performance of cleaning preparations and especially dish detergents, preferably automatic dish detergents.

In another embodiment, the present invention relates to preparations containing 0.1 to 15% by weight of the mixtures according to the invention and other ingredients typically present in cleaning preparations and preferably in dish detergents. The cleaning preparations preferably contain the mixtures according to the invention in quantities of 0.1 to 8% by weight, advantageously in quantities of 1 to 6.0% by weight and more particularly in quantities of 2.0 to 5% by weight. Quantities in the range from 2.0 to 4.0% by weight are particularly preferred.

The typical ingredients of the preparations according to the invention as described in the foregoing may be, for example, other nonionic, anionic an/or cationic surfactants, builders, enzymes, bleaching agents, such as percarbonates for example. The preparations may also contain silicates, phosphorus compounds, carbonates and also special rinse agents and other known and typical auxiliaries and additives, for example pH adjusters and enzymes, solvents, such as water or lower aliphatic alcohols, preferably ethanol or propanol, solubilizers, polymers or organic acids, preferably citric acid, and derivatives thereof.

The cleaning preparations may be both liquid and solid, for example in the form of granules, powders or tablets. Liquid cleaning preparations may also contain thickeners, for example in order to obtain gel-form preparations.

Automatic dish detergents are preferably present in solid form, for example as powders or granules or as shaped bodies, for example tablets. In this case, several phases may be present alongside one another, for example a tablet which, in a recess, contains a non-compressed part, for example a wax-like rinse agent phase. Multifunctional preparations such as these are marketed as 2-in-1 or even 3-in-1 products.

The preparations are produced by any method known to the expert. In a preferred embodiment, the mixtures according to the invention are present as a compound and are preferably mixed with the other ingredients in any order.

### EXAMPLES

a) Drying Behavior

Drying behavior was tested by the following method. The drying of tableware was evaluated after the drying phase of a Miele G 696 SC dishwasher, program: 55° C.—Universal Plus, water hardness: 16° dH. The machine was filled with a practically relevant load of 24 china plates, 6 styrene/acrylonitrile (SAN) plates, 2 polypropylene (PP) bowls, 40 pieces of stainless steel cutlery. The test soil is: 50 g soil with the following composition: based on 1000 g: mixture of 25 g ketchup, 25 g mustard and 25 g gravy, 300 g margarine, 150 g drinking milk, 15 g potato starch, 9 g egg yolk, 3 g benzoic acid, rest: water. Each surfactant tested was subjected three times to a wash cycle and, after the drying phase, was tested for drying behavior. The same light conditions and room humidity and room temperature were always established.

Drying behavior was evaluated as follows:
0=0 water droplets on a substrate=best result, dry
1=1 water droplet on a substrate
2=2 water droplets on a substrate
3=3 water droplets on a substrate
4=4 water droplets on a substrate
5=5 water droplets on a substrate
6=more than 5 water droplets on a substrate, worst result
   b) Clear-Rinse Performance

Clear-rinse performance was evaluated by the following method: the substrates from drying test a) were again visually evaluated, but only the glass substrates were tested.

Both spotting and filming were evaluated using the following scale:

| Score | Spotting | Filming |
|---|---|---|
| 1 | No spots | No filming |
| 2 | Very few spots | Very little filming |
| 3 | A few spots | Slight filming |
| 4 | Many spots | Serious filming |
| 5 | Very many spots | Very serious areal filming |

A score of 1 represents the best result, a score of 5 the worst result.

In the Examples for the testing of drying properties, the average values over all substrates and also glass and plastic were shown as a separate result. Various surface-active compounds were used on their own and in combination for the tests.

The following standard formulation was used:

| Substance | % by weight |
|---|---|
| Surface-active compound | 4 |
| Sodium silicate (SKS-6) | 7 |
| Sodium tripolyphosphate | 51 |
| TAED (tetraacetyl ethylenediamine) | 2.5 |
| Sodium carbonate | 27.5 |
| Sodium percarbonate | 8 |

Surface active compounds tested:
A HME of formula (I) with R¹=C₈₋₁₀; R²=C₁₀, x=40
B HME of formula (I) with R¹=C₈₋₁₀; R²=C₁₀, x=40; M=butyl
C HME of formula (II) with R³=C₁₁; R⁴=C₈, y=22, z=0
D HME of formula (II) with R³=C₈₋₁₀, R⁴=C₈, y=22, z=0
E polyethylene glycol derivative of type b3) with R⁶=C₁₁ and R⁷=COR⁶
F tallow alcohol b2) with 2 parts ethylene oxide per mol alcohol
G tallow alcohol b2) with 5 parts ethylene oxide per mol alcohol
H betaine b5) based on coconut oil fatty acid (Dehyton®) AB 30, Cognis)
K alkyl (oligo)glucoside b4) (Glucopon® 600 CS UP, Cognis)

Table 1 shows how the evaluation of drying behavior via the average results of all substrates can appear. At the same time, the results in Table 1 demonstrate the prior art and a water value, i.e. in this case no detergent or other additives were introduced into the dishwasher.

TABLE 1

| Formulation | Droplet count |
|---|---|
| ADD detergent with conventional | 0.8 |
| rinse agent | |
| 3-in-1 Commercial product | 3.6 |
| Water | 4.1 |

Table 2 below shows the results of the drying test described above in a) for various formulations and various substrates (glass, plastic and total). The basic test formulation described above was used in a quantity of 25 g. The number of droplets on the particular surface is shown. The results of the clear-rinse test b) on glass are shown in the two right-hand columns of Table 2.

It can be seen that, as expected, water on its own (test 18) gives the worst result in regard to drying and clear-rinse performance. However, the detergent formulation on its own (test 17) also shows poor overall drying and clear-rinse performance. Although the addition of individual surfactants (tests 1, 4, 7, 8, 10, 12 and 15) leads partly either to an improvement in drying or to an improvement in clear-rinse performance, only the combination of type a) and type b) surfactants according to the invention improves both the drying behavior and the clear-rinse performance of the test formulation.

TABLE 2

| | Quantity of | | | | | |
|---|---|---|---|---|---|---|
| | surface-active | | | | Clear-rinse | |
| | compound(s) | | | | performance | |
| Test | in 25 g of | | | | on glass | |
| No. | standard formulation | Glass | Plastic | Total | Spotting | Filming |
| 1 | 2% by weight A | 0.8 | 2.3 | 2 | 1.5 | 1.5 |
| 2 | 2% by weight A | 0.2 | 0.5 | 0.8 | 1 | 1 |
| | 2% by weight C | | | | | |
| 3 | 2% by weight A | 0.2 | 0.7 | 0.8 | 1 | 1 |
| | 2% by weight D | | | | | |
| 4 | 4% by weight E | 0.4 | 0.9 | 1.1 | 2 | 2 |
| 5 | 2% by weight A | 0.6 | 1.0 | 1.2 | 1 | 1 |
| | 2% by weight E | | | | | |
| 6 | 2% by weight A | 0.3 | 0.9 | 1.3 | 1 | 1 |
| | 1% by weight B | | | | | |
| 7 | 4% by weight B | 0.4 | 0.9 | 1.2 | 3 | 3 |
| 8 | 4% by weight G | 0.3 | 0.5 | 0.7 | 4 | 4 |
| 9 | 2% by weight A | 0.3 | 0.6 | 1.1 | 1 | 1 |
| | 2% by weight G | | | | | |
| 10 | 4% by weight H | 0.5 | 1.8 | 1.3 | 2.5 | 2 |
| 11 | 2% by weight A | 0.3 | 1.1 | 1.2 | 1 | 1 |
| | 2% by weight H | | | | | |
| 12 | 4% by weight F | 0.3 | 0.7 | 0.9 | 4 | 4 |
| 13 | 2% by weight A | 0.4 | 0.8 | 1.1 | 1 | 1.5 |
| | 2% by weight F | | | | | |
| 14 | 2% by weight A | 0.3 | 0.8 | 1.1 | 1 | 1 |
| | 1% by weight F | | | | | |
| 15 | 2% by weight K | 0.4 | 1.8 | 1.5 | 3 | 2 |
| 16 | 2% by weight A | 0.2 | 0.6 | 0.9 | 1 | 1 |
| | 2% by weight K | | | | | |
| 17 | 0% | 1.3 | 4.1 | 3.1 | 4 | 5 |
| 18 | Water only | 5.8 | 4.9 | 4.1 | 5 | 5 |

What is claimed is:

1: A mixture of at least two structurally different surface-active compounds, at least one of which is from group a) and one or more of which is from groups b1) to b8), the surface-active compound a) being selected from one or more hydroxy mixed ether compounds corresponding to general formula (I):
R¹O[CH₂CH₂O]ₓCH₂CH(OM)R² (I)
in which R¹ is a linear or branched alkyl and/or alkenyl group containing 4 to 22 carbon atoms or an R²—CH(OH)CH₂ group, where R² is a linear or branched alkyl and/or alkenyl group containing 8 to 16 carbon atoms, x is a number from 40 to 80 and M is a hydrogen atom or a saturated alkyl group containing 1 to 18 carbon atoms;
and the one or more structurally different surface-active compounds b) being selected from one or more of the groups b1) to b8):
b1) hydroxy mixed ether compounds corresponding to formula (II):
R³O[CH₂CH₂O]_{y}[CH₂CHCH₃O]_{z}CH₂CH(OH)R⁴ (II)
in which R³ is a linear or branched alkyl and/or alkenyl group containing 8 to 22 carbon atoms, R⁴ is a linear or branched alkyl and/or alkenyl group containing 8 to 16 carbon atoms, y is a number from 10 to 35, z is 0 or a number from 1 to 5, with the proviso that, where R³═R¹ and at the same time R⁴═R², z must be at least 1;
b2) ethoxylated fatty alcohols corresponding to general formula (III):
R⁵—(OC₂H₄)_{z}—OH (III)
in which R⁵ represents linear or branched alkyl and/or alkenyl groups containing 8 to 22 carbon atoms and n is a number from 1 to 20;
b3) esters of (poly)glycols corresponding to general formula (IV)
R⁶CO—(OC₂H₄)ₘ—OR⁷ (IV)
in which R⁶ represents an alkyl and/or alkenyl group containing 7 to 21 carbon atoms and m is a number from 11 to 100 and R⁷ is a hydrogen atom or a CO—R⁶ group;
b4) alkyl (oligo)glycosides corresponding to the general formula (V)
R⁸O—[G]ₚ (V)
where R⁸ is an alkyl and/or alkenyl group containing 4 to 22 carbon atoms, G is a sugar unit containing 5 or 6 carbon atoms and p is a number from 1 to 10;
b5) betaines;
b6) compounds corresponding to general formula (VI): 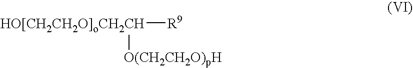
in which R⁹ is a linear or branched alkyl and/or alkenyl group containing 4 to 22 carbon atoms, o is a number from 1 to 20 and the index p is 0 or a number from 1 to 20;
b7) compounds corresponding to general formula (VII):
R¹⁰CH(OR¹¹)CH₂—OR¹¹ (VII)
in which R¹⁰ is a saturated or unsaturated, branched or unbranched alkyl or alkenyl group containing 8 to 16 carbon atoms and the substituents R¹¹ independently of one another symbolize a group (CH₂CH₂O)ᵣCH₂CH(OH)R¹², r in each substituent R¹¹ independently standing for 0 or a number from 1 to 50 and R¹² being a saturated or unsaturated, branched or unbranched alkyl or alkenyl group containing 8 to 16 carbon atoms; and
b8) compounds corresponding to general formula (VIII):
NR¹³₃ (VIII)
in which the substituents R¹³ independently of one another represent a (CH₂CH₂O)ₛCH₂CH(OH)R¹⁴ group or an alkyl group containing 8 to 16 carbon atoms and s for each substituent R¹³ independently stands for 0 or a number from 1 to 50,
with the proviso that the ratio by weight between the surface-active compounds a) and b) is in the range from 10:1 to 1:10.

2: A mixture according to claim 1, containing only one surface-active compound a) in combination with only one surface-active compound b1).

3: A mixture according to claim 1, wherein the index x in formula (I) is a number from 40 to 70.

4: A mixture according to claim 2, wherein the index x in formula (I) is a number from 40 to 70.

5: A mixture according to claim 2, wherein the index y in formula (II) is a number from 20 to 30.

6: A mixture according to claim 1, wherein only one surface-active compound of type a) and one surface-active compound of type b) is present and they are present in a ratio by weight of 5:1 to 1:5.

7: A mixture according to claim 2, wherein the surface-active compounds of type a) and b1) are present in a ratio by weight of 3:1 to 1:3.

8: A mixture according to claim 1, containing a compound of general formula (I), in which R¹ is an alkyl and/or alkenyl group containing 8 to 10 carbon atoms and R² is an alkyl or alkenyl group containing 8 to 10 carbon atoms and x is a number from 40 to 50, as the surface-active compound of type a).

9: A mixture according to claim 2, containing a compound of general formula (I), in which R¹ is an alkyl and/or alkenyl group containing 8 to 10 carbon atoms and R² is an alkyl or alkenyl group containing 8 to 10 carbon atoms and x is a number from 40 to 50, as the surface-active compound of type a).

10: A mixture according to claim 2, containing a compound of general formula (II), in which R³ is an alkyl and/or alkenyl group containing 11 to 18 carbon atoms and R⁴ is an alkyl or alkenyl group containing 8 to 10 carbon atoms and y is a number from 20 to 35, as the surface-active compound of type b).

11: A mixture according to claim 2, containing a compound of general formula (II), in which R³ is an alkyl and/or alkenyl group containing 8 to 12 carbon atoms and R⁴ is an alkyl or alkenyl group containing 8 to 10 carbon atoms, y is a number from 20 to 35 and z is a number from 1 to 3, as the surface-active compound of type b).

12: A detergent composition for cleaning hard surfaces, comprising 0.1 to 8% by weight of mixtures containing at least two structurally different surface-active compounds, at least one of which is from group a) and one or more of which is from groups b1) to b8), the surface-active compound a) being selected from one or more hydroxy mixed ether compounds corresponding to general formula (I):
R¹O[CH₂CH₂O]ₓCH₂CH(OM)R² (I)
in which R¹ is a linear or branched alkyl and/or alkenyl group containing 4 to 22 carbon atoms or an R²—CH(OH)CH₂ group, where R² is a linear or branched alkyl and/or alkenyl group containing 8 to 16 carbon atoms, x is a number from 40 to 80 and M is a hydrogen atom or a saturated alkyl group containing 1 to 18 carbon atoms;
and the structurally different surface-active compound b) being selected from one or more of the groups b1) to b8):
b1) hydroxy mixed ether compounds corresponding to formula (II):
R³O[CH₂CH₂O]_{y}[CH₂CHCH₃O]_{z}CH₂CH(OH)R⁴ (II)
in which R³ is a linear or branched alkyl and/or alkenyl group containing 8 to 22 carbon atoms, R⁴ is a linear or branched alkyl and/or alkenyl group containing 8 to 16 carbon atoms, y is a number from 10 to 35, z is 0 or a number from 1 to 5, with the proviso that, where R³═R¹ and at the same time R⁴=R², z must be at least 1;
b2) ethoxylated fatty alcohols corresponding to general formula (III):
R⁵—(OC₂H₄)_{z}—OH (III)
in which R⁵ represents linear or branched alkyl and/or alkenyl groups containing 8 to 22 carbon atoms and n is a number from 1 to 20;
b3) esters of (poly)glycols corresponding to general formula (IV)
R⁶CO—(OC₂H₄)ₘ—OR⁷ (IV)
in which R⁶ represents an alkyl and/or alkenyl group containing 7 to 21 carbon atoms and m is a number from 11 to 100 and R⁷ is a hydrogen atom or a CO—R⁶ group;
b4) alkyl (oligo)glycosides corresponding to the general formula (V)
R⁸O—[G]ₚ (V)
where R⁸ is an alkyl and/or alkenyl group containing 4 to 22 carbon atoms, G is a sugar unit containing 5 or 6 carbon atoms and p is a number from 1 to 10;
b5) betaines;
b6) compounds corresponding to general formula (VI): 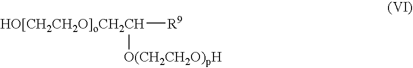
in which R⁹ is a linear or branched alkyl and/or alkenyl group containing 4 to 22 carbon atoms, o is a number from 1 to 20 and the index p is 0 or a number from 1 to 20;
b7) compounds corresponding to general formula (VII):
R¹⁰CH(OR¹¹)CH₂—OR¹¹ (VI)
in which R¹⁰ is a saturated or unsaturated, branched or unbranched alkyl or alkenyl group containing 8 to 16 carbon atoms and the substituents R¹¹ independently of one another symbolize a group (CH₂CH₂O)ᵣCH₂CH(OH)R¹², r in each substituent R¹¹ independently standing for 0 or a number from 1 to 50 and R¹² being a saturated or unsaturated, branched or unbranched alkyl or alkenyl group containing 8 to 16 carbon atoms; and
b8) compounds corresponding to general formula (VIII):
NR¹³₃ (VIII)
in which the substituents R¹³ independently of one another represent a (CH₂CH₂O)ₛCH₂CH(OH)R¹⁴ group or an alkyl group containing 8 to 16 carbon atoms and s for each substituent R¹³ independently stands for 0 or a number from 1 to 50,
with the proviso that the ratio by weight between the surface-active compounds a) and b) is in the range from 10:1 to 1:10.

13: A detergent composition according to claim 12, containing only one surface-active compound a) in combination with only one surface-active compound b1).

14: A detergent composition according to claim 12, wherein the index x in formula (I) is a number from 40 to 70.

15: A detergent composition according to claim 13, wherein the index x in formula (I) is a number from 40 to 70.

16: A detergent composition according to claim 13, wherein the index y in formula (II) is a number from 20 to 30.

17: A detergent composition according to claim 12, wherein only one surface-active compound of type a) and one surface-active compound of type b) is present and they are present in a ratio by weight of 5:1 to 1:5.

18: A detergent composition according to claim 13, wherein the surface-active compounds of type a) and b1) are present in a ratio by weight of 3:1 to 1:3.

19: A detergent composition according to claim 12, containing a compound of general formula (I), in which R¹ is an alkyl and/or alkenyl group containing 8 to 10 carbon atoms and R² is an alkyl or alkenyl group containing 8 to 10 carbon atoms and x is a number from 40 to 50, as the surface-active compound of type a).

20: A detergent composition according to claim 13, containing a compound of general formula (I), in which R¹ is an alkyl and/or alkenyl group containing 8 to 10 carbon atoms and R² is an alkyl or alkenyl group containing 8 to 10 carbon atoms and x is a number from 40 to 50, as the surface-active compound of type a).

21: A detergent composition according to claim 13, containing a compound of general formula (II), in which R³ is an alkyl and/or alkenyl group containing 11 to 18 carbon atoms and R⁴ is an alkyl or alkenyl group containing 8 to 10 carbon atoms and y is a number from 20 to 35, as the surface-active compound of type b).

22: A detergent composition according to claim 13, containing a compound of general formula (II), in which R³ is an alkyl and/or alkenyl group containing 8 to 12 carbon atoms and R⁴ is an alkyl or alkenyl group containing 8 to 10 carbon atoms, y is a number from 20 to 35 and z is a number from 1 to 3, as the surface-active compound of type b).

23: The detergent composition of claim 12 which is a dishwashing detergent.

24: A method of improving the spot and streak-free drying capability of a dishwashing detergent, comprising including in such dishwashing detergent 0.1 to 8% by weight of a mixture of one surface-active compound from group a) and one structurally different surface-active compound from groups b1) to b8),
the surface-active compound a) being selected from one or more hydroxy mixed ether compounds corresponding to general formula (I):
R¹O[CH₂CH₂O]ₓCH₂CH(OM)R² (I)
in which R¹ is a linear or branched alkyl and/or alkenyl group containing 4 to 22 carbon atoms or an R²—CH(OH)CH₂ group, where R² is a linear or branched alkyl and/or alkenyl group containing 8 to 16 carbon atoms, x is a number from 40 to 80 and M is a hydrogen atom or a saturated alkyl group containing 1 to 18 carbon atoms;
and the surface-active compound b) being selected from one of the groups b1) to b8):
b1) hydroxy mixed ether compounds corresponding to formula (II):
R³O[CH₂CH₂O]_{y}[CH₂CHCH₃O]_{z}CH₂CH(OH)R⁴ (II)
in which R³ is a linear or branched alkyl and/or alkenyl group containing 8 to 22 carbon atoms, R⁴ is a linear or branched alkyl and/or alkenyl group containing 8 to 16 carbon atoms, y is a number from 10 to 35, z is 0 or a number from 1 to 5, with the proviso that, where R³=R¹ and at the same time R⁴═R², z must be at least 1;
b2) ethoxylated fatty alcohols corresponding to general formula (III):
R⁵—(OC₂H₄)_{z}—OH (III)
in which R⁵ represents linear or branched alkyl and/or alkenyl groups containing 8 to 22 carbon atoms and n is a number from 1 to 20;
b3) esters of (poly)glycols corresponding to general formula (IV)
R⁶CO—(OC₂H₄)ₘ—OR⁷ (IV)
in which R⁶ represents an alkyl and/or alkenyl group containing 7 to 21 carbon atoms and m is a number from 11 to 100 and R⁷ is a hydrogen atom or a CO—R⁶ group;
b4) alkyl (oligo)glycosides corresponding to the general formula (V)
R⁸O—[G]ₚ (V)
where R⁸ is an alkyl and/or alkenyl group containing 4 to 22 carbon atoms, G is a sugar unit containing 5 or 6 carbon atoms and p is a number from 1 to 10;
b5) betaines;
b6) compounds corresponding to general formula (VI): 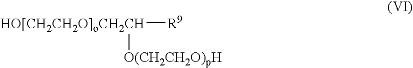
in which R⁹ is a linear or branched alkyl and/or alkenyl group containing 4 to 22 carbon atoms, o is a number from 1 to 20 and the index p is 0 or a number from 1 to 20;
b7) compounds corresponding to general formula (VII):
R¹⁰CH(OR¹¹)CH₂—OR¹¹ (VII)
in which R¹⁰ is a saturated or unsaturated, branched or unbranched alkyl or alkenyl group containing 8 to 16 carbon atoms and the substituents R¹¹ independently of one another symbolize a group (CH₂CH₂O)ᵣCH₂CH(OH)R², r in each substituent R¹¹ independently standing for 0 or a number from 1 to 50 and R¹² being a saturated or unsaturated, branched or unbranched alkyl or alkenyl group containing 8 to 16 carbon atoms; and
b8) compounds corresponding to general formula (VIII):
NR¹³₃ (VIII)
in which the substituents R¹³ independently of one another represent a (CH₂CH₂O)ₛCH₂CH(OH)R¹⁴ group or an alkyl group containing 8 to 16 carbon atoms and s for each substituent R¹³ independently stands for 0 or a number from 1 to 50,
with the proviso that the ratio by weight between the surface-active compounds a) and b) is in the range from 10:1 to 1:10.

25: The method of claim 24, characterized in that only one surface-active compound of type a) and one surface-active compound b1) are present alongside one another in a ratio by weight of 5:1 to 1:5
